(19) United States
(12) Patent Application Publication
(10) Pub. No.: US 2009/0248641 A1
(43) Pub. Date: Oct. 1, 2009

(54) METHOD AND APPARATUS FOR DETECTING ANOMALISTIC DATA RECORD

(76) Inventors: Ning Duan, Beijing (CN); Zhong Jie Li, Beijing (CN); He Hui Liu, Beijing (CN); Hua Fang Tan, Beijing (CN); Jun Zhu, Beijing (CN)

Correspondence Address: IBM CORPORATION, T.J. WATSON RESEARCH CENTER, P.O. BOX 218, YORKTOWN HEIGHTS, NY, 10598, US

(21) Appl. No.: 12/409,892

(22) Filed: Mar. 24, 2009

(30) Foreign Application Priority Data
Mar. 25, 2008 (CN) 200810084562.3

(51) Int. Cl. G06F 17/30

(52) U.S. Cl. 707/3; 707/E17.014; 707/100; 707/200; 707/E17.044

(57) ABSTRACT

A method and apparatus for detecting an anomalistic data record. The method includes the steps of mining a data rule from a verified data record set in accordance with a mining rule, checking data records in an unverified data record set in accordance with the mined data rule and determining a data record unconformable to the mined data rule as an anomalistic data record. The apparatus includes a mining device configured to mine a data rule from a verified data record set in accordance with a mining rule and a checking device configured to check a data record in an unverified data record set in accordance with the mined data rule and to determine a data record unconformable to the mined data rule as an anomalistic data record.

### CROSS REFERENCE TO RELATED APPLICATION

This application claims priority under 35 U.S.C. § 119 from Chinese Patent Application No. 200810084562.3 filed Mar. 25, 2008, the entire contents of which are incorporated by reference herein.

### BACKGROUND OF THE INVENTION

1. Field of the Invention

The present invention relates to a database system. More particularly, the present invention relates to a method and apparatus for detecting an anomalistic data record.

2. Description of the Related Art

In a database application system, it is often required to test whether the database application system can be manipulated normally with a data record existing in a database. If there are a large number of data records in the database, it is difficult to test all of the data records and therefore it is necessary to select some representative data records for testing.

For example, during data migration, a migration rule is applied to migrate data in a system (referred to as source system hereinafter) into another system (referred to as destination system hereinafter). However, it is nearly impossible to write out a completely correct migration rule with limited time/resources during data migration. Consequently, it can not be guaranteed that the destination system could work normally with migrated data even if the data is migrated strictly following the migration rule in many cases. It is required to test the migrated data from a user side to validate whether the destination system can work normally with the migrated data. However in practice, the migrated data involves a large number of data records and enormous different user accounts. Therefore, it is difficult to log in each of the user accounts to test all the data records. It is required in this case to select some data records from the migrated data for testing.

Conventionally, in a method for selecting data records to be tested, a person familiar with the system selects directly data records to be tested. In another method for selecting data records to be tested, a person familiar with the system divides the data records into several groups according to the meaning thereof and then samples one data record to be tested from each of the groups. These methods may be inefficient with a large number of data records. Therefore there is a need of improving the efficiency of selecting data records to be tested.

### SUMMARY OF THE INVENTION

The present invention provides a method and apparatus which can improve an efficiency of selecting data records to be tested.

According to one aspect of the invention, there is provided a method for detecting an anomalistic data record including the steps of: mining a data rule from a verified data record set in accordance with a mining rule, checking a data record in an unverified data record set in accordance with the mined data rule, and determining a data record unconformable to the mined data rule as an anomalistic data record.

According to another aspect of the invention, there is provided an apparatus for detecting an anomalistic data record including: a mining device configured to mine a data rule from a verified data record set in accordance with a mining rule and a checking device configured to check a data record in an unverified data record set in accordance with the mined data rule and to determine a data record unconformable to the mined data rule as an anomalistic data record.

The inventive method and apparatus for detecting an anomalistic data record can be applied to select a data record to be tested. Detected anomalistic data records can be determined directly as data records to be tested or can be filtered manually to select a data record to be tested, and in either of the cases the use of the invention can improve an efficiency of selecting a data record to be tested.

### BRIEF DESCRIPTION OF THE DRAWINGS

The above, features and advantages of the invention will be understood readily from the following descriptions of the preferred embodiments thereof taken in conjunction with the accompanying drawings, wherein:

FIG. 1 illustrates a distributed data processing system in which the invention can be implemented.

FIG. 2 illustrates a data processing system in which the invention can be implemented.

FIG. 3 illustrates a method for detecting an anomalistic data record according to an embodiment of the invention.

FIG. 4 illustrates a method for detecting an anomalistic data record according to another embodiment of the invention.

FIG. 5 illustrates an apparatus for detecting an anomalistic data record according to an embodiment of the invention.

FIG. 6 illustrates an apparatus for detecting an anomalistic data record according to another embodiment of the invention.

### DETAILED DESCRIPTION OF THE PREFERRED EMBODIMENTS

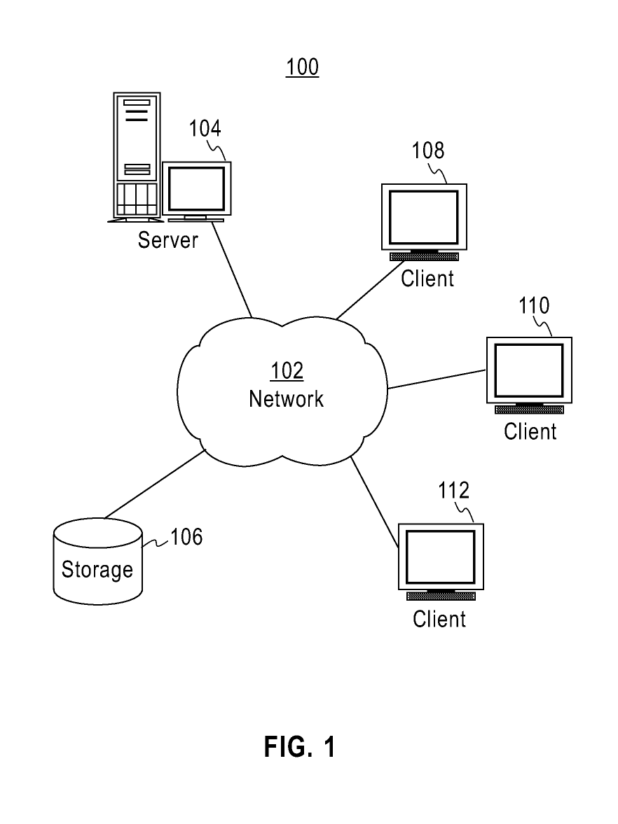

A distributed data processing system 100 of the invention will be described with reference to the drawings, particularly FIG. 1. A distributed data processing system 100 includes a network 102, which is a medium for providing a communication link between computers connected together in the distributed data processing system 100.

In the example as illustrated, a server 104 and a storage 106 are connected with the network 102. Further, clients 108, 110 and 112 are also connected with the network 102. The distributed data processing system 100 can include additional servers, clients and other apparatus not shown. In the example as illustrated, the distributed data processing system 100 is the Internet and the network 102 represents a set of networks and gateways in communication with each other by means of the TCP/IP protocol suite. Of course, the distributed data processing system 100 can alternatively be implemented as a different type of network.

FIG. 1 is merely illustrative and the system illustrated in FIG. 1 can be modified variously without departing from the spirit and scope of the invention.

The invention can be implemented as a data processing system of the server 104 illustrated in FIG. 1. This data processing system may be a Symmetric Multi-Processor (SMP) system including a plurality of processors connected with a system bus or a single processor system. The invention can alternatively be implemented as a data processing system of a client illustrated in FIG. 1.

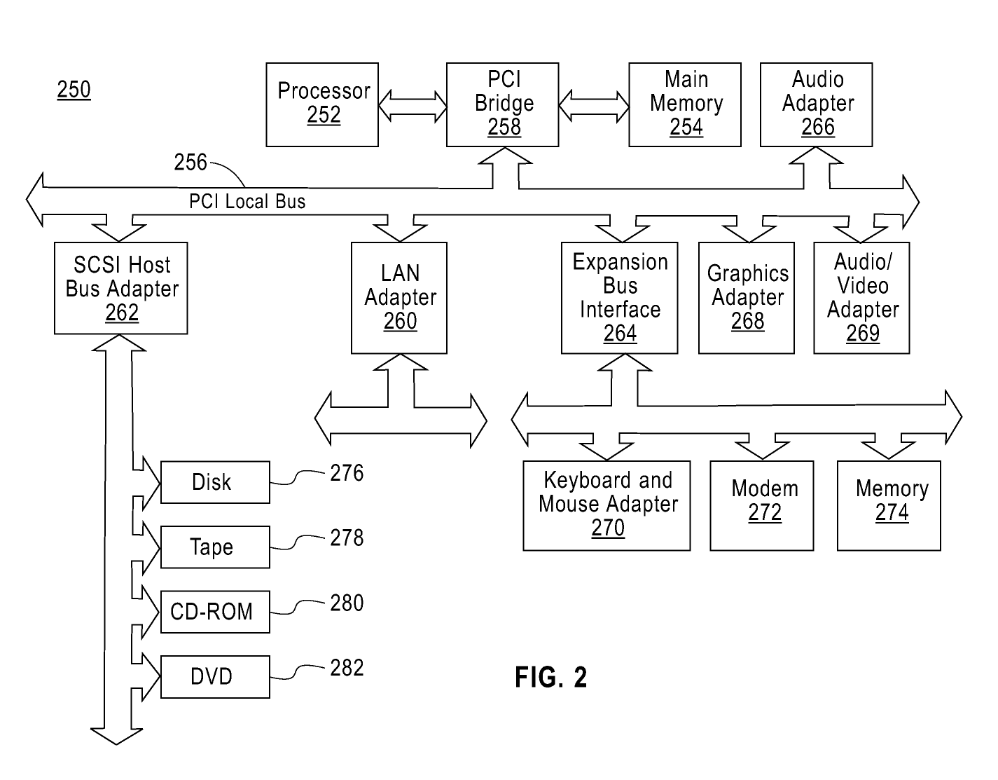

A block diagram of a data processing system in which the invention can be implemented will be described illustratively with reference to FIG. 2. A data processing system 250 is a client computer as an example. The data processing system 250 makes use of a local bus structure of Peripheral Component Interconnection (PCI). Although a PCI bus is used in the example as illustrated, other bus structures, for example micro channel, ISA can also be used. A processor 252 and a main memory 254 are connected with a PCI local bus 256 via a PCI bridge 258. For the processor 252, the PCI bridge 258 can further include a memory buffer and a high-speed buffer which are integrated. Additional connections to the PCI local bus 256 may be made through a direct component interconnection or an add-in board.

In the example as illustrated, a Local Area Network (LAN) adapter 260, an SCSI host bus adapter 262 and an expansion bus interface 264 are connected with the PCI local bus 256 via a direct component interconnection. In contrast, an audio adapter 266, a graphics adapter 268 and an audio/video (A/V) adapter 269 are connected with the PCI local bus 256 via add-in boards, which are inserted in extension slots. The expansion bus interface 264 provides connections for a keyboard and mouse adapter 270, a modem 272 and an additional memory 274. In the example as illustrated, the SCSI host bus adapter 262 provides connections for a disk 276, a tape 278, a CD-ROM 280 and a DVD 282. A typical PCI local bus implementation can support three or four PCI extension slots or add-in connectors.

An operating system runs on the processor 252 to coordinate and control the respective components in the data processing system 250 illustrated in FIG. 2. This operating system can be a commercially available operating system.

In an embodiment of the invention, a database may include one or more tables. A row in each of the tables is referred to as a data record and a column is referred to as a field column. If a table includes m rows and n columns (m and n are natural numbers), it includes m data records and n field columns, where the data records each include n fields.

In an embodiment of the invention, a verified data record refers to a data record determined to be capable of being manipulated normally in a database application system, which typically is a data record that has been manipulated without error in the database application system for a considerable period of time. How to obtain a verified data record is known to those skilled in the art and therefore will not be described here. An unverified data record refers to a data record, which has not been determined regarding whether it can be manipulated normally in the system. For example, an unverified data record may be a data record migrated into the system from outside, for example through data migration or otherwise.

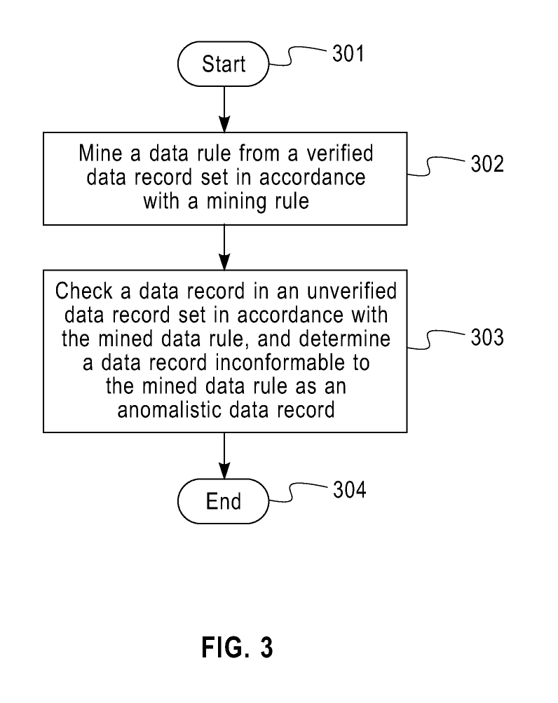

FIG. 3 illustrates a method for detecting an anomalistic data record according to an embodiment of the invention.

The method starts with step 301.

In step 302, a data rule is mined from a verified data record set in accordance with a mining rule.

The verified data record set includes of one or more verified data records and may include data records in different tables.

A data rule refers to any pattern or feature of data records. For example, all data of a field is of a numeral type, which can be referred to as a data rule. Mining a data rule from a data record set is finding a data rule that each of the data records in the data record set follows.

A data rule can be considered as being consisted of three parts, an object, a property and a value. For example in a data rule that “Field A is Not Allowed to be Null,” the object of the data rule is “Field A,” the property is “Whether the data is allowed to be Null,” and the value is “Not.” A data rule may involve numerous properties. A property may be relevant to a data type of a field, in other words, the property applies only to a field of a specific data type, or may be irrelevant to a data type of a field. The property applies a field of any data type. The data type may include a character type, a numeral type, a temporal type, an image type and a video type. The data type may be a further specific data type. For example, the character type may include VARCHAR, CHAR, TEXT; the numerical type may include INT, LONG, FLOAT, BIGINT, DOUBLE, DECIMAL; and the temporal type may include DATE, TIME, DATETIME, MONTH, YEAR. The names of data types as mentioned here are only illustrative and a name of the same data type may vary from one database system to another without departing from the scope of the invention. A data type of a field can be determined in any way known to those skilled in the art, which will not be described in details here. An object corresponding to a property in a data rule may be one field or a plurality of fields, and the plurality of fields may be in the same or different tables. A property corresponding to one field may include: whether the field is allowed to be null; a length range of a character-type field; the maximum sub-string and/or a location of the maximum sub-string of a character-type field, where the maximum sub-string refers to the maximum sub-string commonly contained in a set of character strings; a character type of a character-type field, where the character type may be a numeral or an English letter; a numerical range of a numeral-type field; a precision range of a numeral-type field; and a temporal range of a temporal-type field. A property corresponding to a plurality of fields may be whether the fields satisfy a functional relationship selected from a group including: a proportional relationship between two numeral-type fields; an inverse proportional relationship between two numeral-type fields; a relationship that a numeral-type field is a sum of another two numeral-type fields; a relationship that a numeral-type field is a difference between another two numeral-type fields; a relationship that a numeral-type field is a product of another two numeral-type fields; and a relationship that a numeral-type field is a quotient of another two numeral-type fields. The ranges mentioned above may include either of upper and lower boundaries or include both of the upper and lower boundaries.

A mining rule specifies an object and a property of a data rule to be mined, or as stated simply below, a mining rule specifies an object to be mined and a property to be mined. For example, a mining rule can specify a numerical range of numeral-type field A, Thus, the object to be mined is the numeral-type field A and the property to be mined is the numerical range.

Different mining rules can be combined. For example, a mining rule specifies mining whether numeral-type field A is null and another mining rule specifies mining a numerical range of numeral-type field A, so the two mining rules can be combined into a mining rule that specifies mining the numerical range of the numeral-type field A and whether the numeral-type field A is null. In another example, a mining rule specifies mining a numerical range of numeral-type field A and another mining rule specifies mining a numerical range of numeral-type field B, so the two mining rules can be combined into a mining rule that specifies mining the numerical ranges of fields A and B. Also, a plurality of mining rules can be involved in step 302.

How to mine a data rule for some specific properties in step 302 will be described illustratively below. If a field in a property is allowed to be null, then the field of each data record in the verified data record set is determined. If the field of one or more data records is null, then the field is determined to be null; otherwise the field is determined not to be null. If a property is a length range of a character-type field, then the maximum and minimum lengths of the field in the verified data record set are determined. Alternatively, only the maximum or minimum length is determined. If the property is the maximum sub-string and/or a location of the maximum sub-string of the character-type field, then any method for determining the maximum sub-string and a location of the maximum sub-string as known in the art can be used to determine the maximum sub-string and the location of the maximum sub-string of the field. If the property is a numerical range of a numeral-type field, then maximum and minimum values of the field in the verified data record set are determined. Alternatively, only the maximum or minimum value is determined. If the property is a precision range of a numeral-type field, then the maximum and minimum precisions of the field in the verified data record set are determined. Alternatively, only the maximum or minimum precision is determined. If the property is a temporal range of a temporal-type field, then the earliest time and the latest time of the field in the verified data record set are determined. Alternatively, only the maximum or minimum time is determined. Those ordinarily skilled in the art can implement a specific algorithm for mining a data rule by means of conventional programming in light of the above illustrative descriptions, and the algorithm and program will not be described here.

In step 303, a data record in an unverified data record set is checked in accordance with the data rule mined in step 302 and a data record unconformable to the mined data rule is determined as an anomalistic data record. Checking the data record in the unverified data record set may include searching for a data record in the unverified data record set and compares the data record against the mined data rule. The search and comparison can be implemented by those of ordinarily skilled in the art based upon their knowledge and skills and therefore will not be described here. The unverified data record set includes at least one unverified data record and possibly a verified data record(s). For example, when one or more unverified data records are added into a verified data record set, the set becomes an unverified data record set. The unverified data record set may include data records in different tables.

The method ends in step 304.

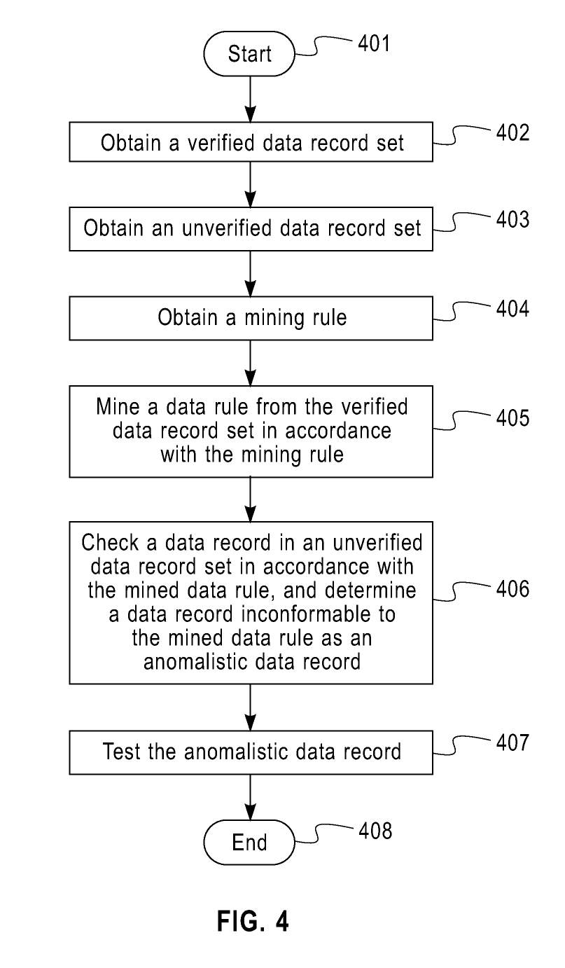

FIG. 4 illustrates a method for detecting an anomalistic data record according to another embodiment of the invention.

The method starts with step 401.

In step 402, a verified data record set is obtained. In step 403, an unverified data record set. In an embodiment, the method further includes forming an unverified data record set through migration of a first data record set into a database to which a verified data record set belongs (not shown in FIG. 4). During data migration, the verified data record set can be backed up in advance, and the migrated data records can be mixed with data records in the backed up verified data record set to form the unverified data record set. The data records can be mixed by adding the migrated data records in a table in the first data record set directly into a corresponding table in the verified data record set. In the case of data migration, the migrated first data record set can alternatively be put into a separate table as the unverified data record set instead of being incorporated into the table in the verified data record set, and in this case, it is not necessary to backup the verified data record set. Of course, the verified data record set and the unverified data record set will not be limited to the data record sets obtained as above. For example, the verified data record set can be obtained from a database and the unverified data record set can be obtained from another database.

For example, those ordinarily skilled in the art can implement an interface by programming via, which a verified data record set or an unverified data record set is obtained by means of direct input or menu selection. The interface together with a display, a keyboard and/or a mouse constitutes a verified-data-record-set obtaining apparatus or an unverified-data-record-set obtaining apparatus through which a human operator can obtain a verified data record set or an unverified data record set. The action of obtaining may include moving or copying a data record set or selecting from existing data record sets, in other words, specifying which data record set is a verified data record set and which data record set is an unverified data record set.

In step 404, a mining rule is obtained. The mining rule can be obtained in various ways. In an embodiment, a mining rule can be stored in a mining rule storage apparatus and thus obtaining the mining rule can be implemented through reading the mining rule from the mining rule storage apparatus. In another embodiment, obtaining a mining rule can be implemented by receiving the mining rule from a human operator. For example, those ordinarily skilled in the art can implement an interface by programming via, which a mining rule is input through direct input or menu selection. The interface together with a display, a keyboard and/or a mouse constitutes a mining rule input apparatus through which a human operator can input a mining rule. The above two ways can be combined to obtain a mining rule. For example, when no mining rule is received from the mining rule input apparatus, a mining rule read from the mining rule storage apparatus is deemed as the obtained mining rule. When a mining rule input from the mining rule input apparatus is received, the mining rule received from the mining rule input apparatus is deemed as the obtained mining rule. Alternatively, an object of a data rule to be mined is read from the mining rule storage apparatus and a property of the data rule to be mined is received from the mining rule input apparatus. Therefore, the object and the property are combined to obtain the data rule. In an embodiment, only a data type of a field is received or read in obtaining the object of the data rule to be mined, and in this instance, the object to be mined can be considered including all fields of the data type, so that a specific field of the object to be mined can be obtained by determining a data type of each field. In an embodiment, only a property to be mined is received or read, and in this case, the object to be mined can be considered including all applicable fields, so that a data type of each field in the verified data record set can be determined to find all match fields as the object of the data rule to be mined. For example, a received or read property is a numerical range but no object to be mined is received or read, and in this case, the mining rule can be considered to be applied to all numeral-type fields. In an embodiment, a property to be mined can be predetermined for a field of a specific data type. In this case, it is possible to receive read-only an object to be mined and the property to be mined can be obtained by determining a data type of each field to be mined. Alternatively, it is possible not to receive or read any object to be mined and an object to be mined can be considered including all applicable fields, so that a data type of each field in the verified data record set can be determined to find all match fields as the object of the data rule to be mined.

In step 405, a data rule is mined from the verified data record set in accordance with the obtained mining rule.

In step 406, data records in an unverified data record set are checked in accordance with the mined data rule and a data record unconformable to the mined data rule is determined as an anomalistic data record.

In step 407, the detected anomalistic data record is tested. In an embodiment, the detected anomalistic data can be further filtered manually and the manually filtered-out data records can be determined as the data to be tested. After determining the data records to be tested, a test case can be constructed from the data records to be tested and then be used to test the data records.

The test case can be constructed from the anomalistic data records obtained and then be used to test the data records as above in various methods known in the art, which will not be described here.

The method ends in step 408.

The order in which the above steps are executed will not be limited to the order as illustrated. Some steps may be executed in parallel or in other orders. For example, step 403 may be executed between steps 405 and 406.

Step 402 of obtaining the verified data record set, step 403 of obtaining the unverified data record set, step 404 of obtaining the mining rule and step 407 of testing the data record are additional in FIG. 4 as compared FIG. 3. It shall be noted that the method including all of the above steps is only a preferred embodiment of the invention and addition of any or all of the above steps is not compulsory. In an embodiment, the verified data record set and the unverified data record set can be default and the steps of obtaining the verified data record set and the unverified data record set are not compulsory. In an embodiment, the mining rule can be predetermined. Thus, the object and the property to be mined can be predetermined and, therefore, the step of obtaining the mining rule is not required. For example, a specific property can be predetermined to be mined for a field of a specific data type. Similarly, the testing step is not compulsory in the method. The testing step is combined directly with the other steps of the method only if the anomalistic data record is tested directly. Practically, the method can end after the anomalistic data record is obtained to achieve the object of the invention. For example, the anomalistic data records can be further filtered manually and the filtered-out data records can be tested. For example, the mining rule can be predetermined. For example, a specific property can be predetermined to be applied to a field of a specific data type.

An embodiment of the invention will be explained below in conjunction with a specific example.

Tables 1 and 2 present structures of a merchandise table and an inventory record table respectively.

TABLE 1
Structure of Merchandise Table

| Field Name | Field Type | Remarks |
|---|---|---|
| ID | VARCHAR(16) | Merchandise ID |
| MERNO | VARCHAR(16) | Merchandise No. |
| NAME | VARCHAR(150) | Merchandise name |
| SPEC | VARCHAR(150) | Merchandise specification |
| DEFPRICE | DECIMAL(15.4) | Default price |

TABLE 2
Structure of Inventory Record Table

| Field Name | Field Type | Remarks |
|---|---|---|
| ID | VARCHAR(16) | Inventory record ID |
| MERID | BIGINT | Merchandise ID |
| TOP | BIGINT | Merchandise inventory top-limit |
| BOTTOM | BIGINT | Merchandise inventory bottom-limit |
| TOTAL | BIGINT | Total inventory |

Tables 1 and 2 are provided merely to facilitate understanding, and it is not necessary to obtain Tables 1 and 2 in advance to implement the invention.

Tables 3 and 4 present original data records in the merchandise table and the inventory record table of a destination system.

TABLE 3
Original Data Records in Merchandise Table

| ID | MERNO | NAME | SPEC | DEFPRICE |
|---|---|---|---|---|
| 001 | 200707061139 | mouse | Lenovo2014 | 85 |
| 002 | ME20070704001515 | refrigerator | H454651243 | 5740 |
| 003 | ME20070705001753 | notebook | T60 | 9000 |

TABLE 4
Original Data Records in Inventory Record Table

| ID | MERID | TOP | BOTTOM | TOTAL |
|---|---|---|---|---|
| 001 | 001 | 10 | 1000 | 500 |
| 002 | 002 | 10 | 300 | 100 |
| 003 | 003 | 10 | 200 | 30 |

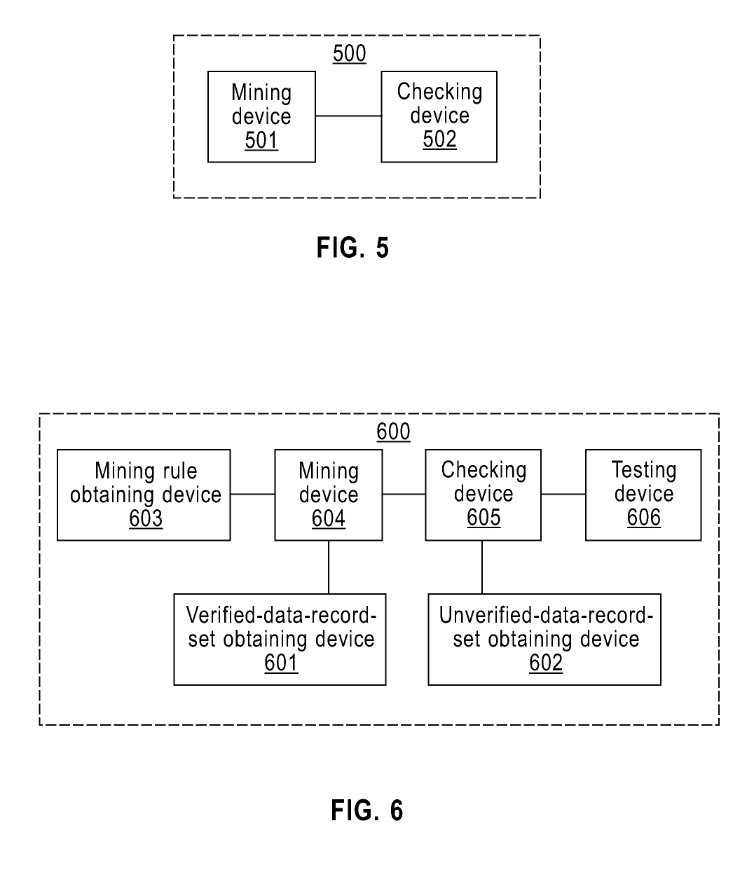

The data in Tables 3 and 4 can be mined in accordance with a mining rule as follows: mining a length range of all character-type fields and a numerical range of all numeral-type fields. The mining rule can be read from the mining rule storage apparatus or input from a human operator. For example, the data type of the field NAME in Table 3 is determined as a character type and, therefore, a length range is mined for the field. During mining the field NAME, lengths of the field NAME of respective data records in Table 3 are determined as 5, 12 and 8, and thus the length range of the field NAME shall be 5-12. Therefore, a data rule mined for the field of NAME is that the length range of the field NAME shall be 5-12. Similarly, the other fields can be mined to obtain data rules illustrated in FIG. 5 and FIG. 6.

FIG. 5: Data rule mined for Merchandise Table

| ID | MERNO | NAME | SPEC | DEFPRICE |
|---|---|---|---|---|
| Length | Length | Length | Length | Numerical |
| range: | range: | range: | range: | range: |
| 3 | 12-16 | 5-12 | 3-10 | 85-9000 |

FIG. 6: Data rule mined for Inventory Record Table

| ID | MERID | TOP | BOTTOM | TOTAL |
|---|---|---|---|---|
| Length | Length | Numerical | Numerical | Numerical |
| range: | range: | range: 10 | range: | range: |
| 3 | 3 | | 200-1000 | 30-500 |

Tables 7 and 8 present data records migrated into the merchandise table and the inventory record table.

TABLE 7
Records migrated into Merchandise Table

| ID | MERNO | NAME | SPEC | DEFPRICE |
|---|---|---|---|---|
| 001 | 200707061150 | rise | good | 150 |
| 002 | KF2007090813 | coffee | netcoffee | 40 |
| 003 | XB0707050017 | sprite | a | 12 |

TABLE 8
Records migrated into Inventory Record Table

| ID | MERID | TOP | BOTTOM | TOTAL |
|---|---|---|---|---|
| 001 | 001 | 0 | 0 | 200 |
| 002 | 002 | 10 | 400 | 300 |
| 003 | 003 | 10 | 600 | 300 |

The data records in Tables 7 and 8 are checked in accordance with the mined data rules illustrated in Tables 5 and 6 to obtain anomalistic data records illustrated in Tables 9 and 10.

TABLE 9
Anomalistic Data Records in Merchandise Table

| ID | MERNO | NAME | SPEC | DEFPRICE |
|---|---|---|---|---|
| 002 | KF2007090813 | coffee | netcoffee | 40 |
| 003 | XB0707050017 | sprite | a | 12 |

TABLE 10
Anomalistic Data Records in Inventory Record Table

| ID | MERID | TOP | BOTTOM | TOTAL |
|---|---|---|---|---|
| 001 | 001 | 0 | 0 | 200 |

After the anomalistic data records illustrated in Tables 9 and 10 are obtained, these data records can be tested directly or can be further filtered manually and the filtered-out data records can be tested.

FIG. 5 illustrates an apparatus 500 for detecting an anomalistic data record according to an embodiment of the invention. The apparatus 500 includes a mining device 501 configured to mine a data rule from a verified data record set in accordance with a mining rule and a checking device 502 configured to check a data record in an unverified data record set in accordance with the mined data rule and to determine a data record unconformable to the mined data rule. Reference can be made to the above descriptions of the method according to the embodiments of the invention for details of operations of the above respective devices.

FIG. 6 illustrates an apparatus 600 for detecting an anomalistic data record according to another embodiment of the invention. The apparatus 600 includes a verified-data-record-set obtaining device 601 configured to obtain a verified data record set, an unverified-data-record-set obtaining device 602 configured to obtain an unverified data record set, a mining rule obtaining device 603 configured to obtain a mining rule, a mining device 604 configured to mine a data rule from the verified data record set in accordance with the obtained mining rule, a checking device 605 configured to check a data record in the unverified data record set in accordance with the mined data rule and to determine a data record unconformable to the mined data rule as an anomalistic data record, and a testing device 606 configured to test the anomalistic data record. In an embodiment, the apparatus 600 can further include a data migration device (not shown in FIG. 6) configured to migrate a first data record set into a database as the unverified data record set. Reference can be made to the above descriptions of the method according to the embodiments of the invention for details of operations of the above respective components.

The verified-data-record-set obtaining device 601, the unverified-data-record-set obtaining device 602, the mining rule obtaining device 603 and the testing device 606 are additional in FIG. 6 as compared FIG. 5. It shall be noted that the apparatus including all the above devices is only a preferred embodiment of the invention and addition of any or all of the above devices is not compulsory. For example, the mining rule can be predetermined. Thus, the object and the property to be mined can be predetermined, and therefore the mining rule obtaining device is not compulsory. If the verified data record set and the unverified data record set are default, then neither the verified-data-record-set obtaining device nor the unverified-data-record-set obtaining device is compulsory. Similarly, the testing device is not compulsory. The testing device can be combined directly with the other devices of the inventive apparatus only if the anomalistic data record is tested directly. Practically, upon the checking device obtaining the anomalistic data record, the object of the invention can be achieved. For example, anomalistic data records can be further filtered manually and the testing device can test the filtered-out data records. For example, the mining rule can be predetermined. For example, a specific property can be predetermined to be applied to a field of a specific data type.

In an embodiment of the invention, the verified data record set and the unverified data record set can be located on the same or different physical mediums or stored in a distributed way.

Those ordinarily skilled in the art can appreciate that all or any of the steps or components of the inventive method and apparatus can be implemented by hardware, firmware, software or a combination thereof in any computing apparatus (including, for example, a processor and a storage medium) or network of computing apparatus. This can be implemented by those ordinarily skilled in the art with their basic programming skills when reading the descriptions of the invention and therefore will not be described here.

Therefore based upon the above understanding, the object of the invention can further be achieved by running a program or a set of programs on any information processing apparatus including any well-known universal apparatus. Stated in another way, such program products and storage mediums where the program products are stored will also come into the scope of the invention. The storage mediums can be any storage mediums well-known or to be developed later and therefore will not be enumerated here.

The components or steps in the apparatus and method of the present invention can be decomposed, combined and/or decomposed and then recombined without departing from the scope of the invention.

The preferred embodiments of the invention have been described above. Those ordinarily skilled in the art will appreciate that the specific details as disclosed here shall not limit the scope of the invention and various modifications and equivalents shall be possible within the spirit and scope of the invention.

What is claimed is:

1. A method for detecting an anomalistic data record, comprising the steps of:
mining a data rule from a verified data record set in accordance with a mining rule;
checking a data record in an unverified data record set in accordance with the mined data rule; and
determining a data record unconformable to the mined data rule as an anomalistic data record.

2. The method according to claim 1, further comprising the step of obtaining a mining rule.

3. The method according to claim 1, wherein the mining rule specifies:
an object; and
a property to be mined, wherein the property is selected from a group consisting of: whether a field is allowed to be null; a length range of a character-type field; the maximum sub-string and/or a location of the maximum sub-string of a character-type field; a character type of a character-type field; a numerical range of a numeral-type field; a precision range of a numeral-type field; a temporal range of a temporal-type field; and whether a plurality of fields satisfy a functional relationship.

4. The method according to claim 3, wherein the functional relationship is selected from a group consisting of: a proportional relationship between two numeral-type fields; an inverse proportional relationship between two numeral-type fields; a relationship that a numeral-type field is a sum of another two numeral-type fields; a relationship that a numeral-type field is a difference between another two numeral-type fields; a relationship that a numeral-type field is a product of another two numeral-type fields; and a relationship that a numeral-type field is a quotient of another two numeral-type fields.

5. The method according to claim 1, further comprising:
obtaining the verified data record set; and
obtaining the unverified data record set.

6. The method according to claim 5, further comprising:
migrating a first data record set into a database to which the verified data record set belongs to form the unverified data record set.

7. The method according to claim 1, further comprising testing the anomalistic data record.

8. An apparatus for detecting an anomalistic data record, comprising:
a mining device configured to mine a data rule from a verified data record set in accordance with a mining rule; and
a checking device configured to check a data record in an unverified data record set in accordance with the mined data rule and to determine a data record unconformable to the mined data rule as an anomalistic data record.

9. The apparatus according to claim 8, further comprising a mining rule obtaining device configured to obtain a mining rule.

10. The apparatus according to claim 8, wherein the mining rule specifies:
an object; and
a property to be mined, wherein the property to be mined is selected from a group consisting of: whether a field is allowed to be null; a length range of a character-type field; the maximum sub-string and/or a location of the maximum sub-string of a character-type field; a character type of a character-type field; a numerical range of a numeral-type field; a precision range of a numeral-type field; a temporal range of a temporal-type field; and whether a plurality of fields satisfy a functional relationship.

11. The apparatus according to claim 10, wherein the functional relationship is selected from a group consisting of: a proportional relationship between two numeral-type fields; an inverse proportional relationship between two numeral-type fields; a relationship that a numeral-type field is a sum of another two numeral-type fields; a relationship that a numeral-type field is a difference between another two numeral-type fields; a relationship that a numeral-type field is a product of another two numeral-type fields; and a relationship that a numeral-type field is a quotient of another two numeral-type fields.

12. The apparatus according to claim 8, further comprising a first data-record-set obtaining device configured to obtain the verified data record set and a second data-record-set obtaining device configured to obtain the unverified data record set.

13. The apparatus according to claim 12, further comprising a data migration device configured to migrate a first data record set into a database to which the verified data record set belongs to form the unverified data record set.

14. The apparatus according to claim 8, further comprising a testing device configured to test the anomalistic data record.
